(19) United States
(12) Patent Application Publication
(10) Pub. No.: US 2009/0073623 A1
(43) Pub. Date: Mar. 19, 2009

(54) APPARATUS AND METHOD FOR SAFETY POWER CONTROL

(75) Inventors: WANTAEK HAN, Hwaseong-si (KR); JEONGJE PARK, Hwaseong-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/057,500

(22) Filed: Mar. 28, 2008

(30) Foreign Application Priority Data
Sep. 14, 2007 (KR) 10-2007-0093461

(51) Int. Cl. H02H 3/20

(52) U.S. Cl. 361/86

(57) ABSTRACT

An apparatus for safety power control is provided. The apparatus comprises first and second electrodes oppositely spaced a predetermined distance to each other; a first voltage generator applying first voltage between the first and second electrodes, a second voltage generator applying, between the first and second electrodes, second voltage for detecting an object put between the first and second electrodes, a voltage meter measuring voltage between the first and second electrodes, and a controller detecting the variance in voltage measured by the voltage meter, and if the measured variance is no less than a predetermined threshold value, cutting off the first voltage, whereby detecting voltage having frequency different from high voltage is applied between electrodes to which the high voltage is applied, the variance in detecting voltage between the electrodes according to ingress of a human body or an object is measured, and if voltage variance above a predetermined value is measured, the high voltage is cut off, so that it is prevented for the human body from being damaged by the high voltage in the apparatus, and that the electrodes for applying high voltage is used as it is, thereby controlling power without installing an additional sensor.

### BACKGROUND OF THE INVENTION

1. Field of the Invention

The present invention relates to an apparatus and method for safety power control, and more particularly to an apparatus and method for safety power control which apply detecting voltage having frequency different from high voltage between electrodes to which the high voltage is applied for keeping foods fresh, measure variation of voltage corresponding to the frequency of the detecting voltage between the electrodes, and if the variation of the voltage exceeds a predetermined threshold value, determine that a human body or the like is positioned between the electrodes, to thereby cut off the high voltage.

2. Description of the Prior Art

As one of the methods for safely storing foods while keeping them fresh, there is a method of supplying electric charges to the foods using electrodes. While a generally used household refrigerator stores foods at a temperature between −2 and −10 degrees, at this temperature range, the refrigerator can only store the foods for at most 3 to 4 days due to deterioration by growth of microbes and oxidation as time passes. However, the foods can be kept fresh for a long period if high voltage is applied to the foods to electrically affect the microbes living in the surface of the foods to thereby restrict the growth of the microbes.

A type of an electric apparatus for keeping the foods fresh includes a positive electrode and a negative electrode at both vertical or lateral sides so that AC or DC high voltage is applied between the electrodes. If the foods to be stored are positioned in the space between both electrodes while being in contact with one of the electrodes, the foods are supplied with electric charges by voltage applied to the electrodes so that it is possible to restrict the growth or microbes in the foods and the oxidation of the foods.

However, in case of such an apparatus using high voltage, when the foods are stored in the apparatus, or they are picked out from the apparatus, there is often the case where a user puts his hand or other human body, or an object in the apparatus. If the hand or a portion of the human body of the user comes into contact with the electrode or the stored foods while the apparatus is in operation, the user is applied with high voltage through the electrode or the foods so that he/she may suffer fatal electrical damage.

A type of currently available method for preventing such damage is to install, on an outer surface of the apparatus, a display lamp displaying the operating state so that when a door of the apparatus is opened during operation of the apparatus, the application of high voltage is stopped by a contact switch. Another method is to install, on the apparatus, a proximity sensor, a temperature sensor, or an infrared sensor so that ingress or egress of the foods for the apparatus is measured using the sensor, and upon occurrence of such an event, the application of high voltage is stopped.

### SUMMARY OF THE INVENTION

The present invention has been made to solve the problems occurring in the prior art, and an object of the present invention is to provide an apparatus and method for safety power control which detect a human body or an object put in the apparatus using electrodes as it is, which applies high voltage for keeping foods fresh, without installing additional sensor, which upon detecting the human body or the object, cuts off the high voltage safely, and which has no malfunction as the apparatus falls into decay.

In accordance with an aspect of the present invention, there is provided an apparatus for safety power control comprising: first and second electrodes oppositely spaced a predetermined distance to each other; a first voltage generator applying first voltage between the first and second electrodes; a second voltage generator applying, between the first and second electrodes, second voltage for defecting an object put between the first and second electrodes; a voltage meter measuring voltage between the first and second electrodes; and a controller detecting the variance in voltage measured by the voltage meter, and if the measured variance is no less than a predetermined threshold value, cutting off the first voltage.

In accordance with another aspect of the present invention, there is provided a method for safety power control comprising the steps of: applying first voltage between a first electrode and a second electrode; applying, between the first and second electrodes, second voltage for detecting an object put between the first and second electrodes; measuring voltage between the first and second electrodes; and detecting the variance in voltage measured, and if the measured variance is no less than a predetermined threshold value, cutting off the first voltage.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a power control apparatus according to an embodiment of the present invention;

FIG. 2 is a flow chart illustrating a procedure of a power control method according to an embodiment of the present invention;

FIG. 3 is a graph illustrating a waveform of voltage measured by a voltage meter when an object is not put between electrodes;

FIG. 4 is a graph illustrating a waveform of voltage measured by a voltage meter when an object is put between electrodes; and

FIG. 5 is a graph illustrating a value obtained by differentiating an envelop value shown in FIG. 4.

### DETAILED DESCRIPTION OF THE EXEMPLARY EMBODIMENTS

Hereinafter, exemplary embodiments of the present invention will be described with reference to the accompanying drawings.

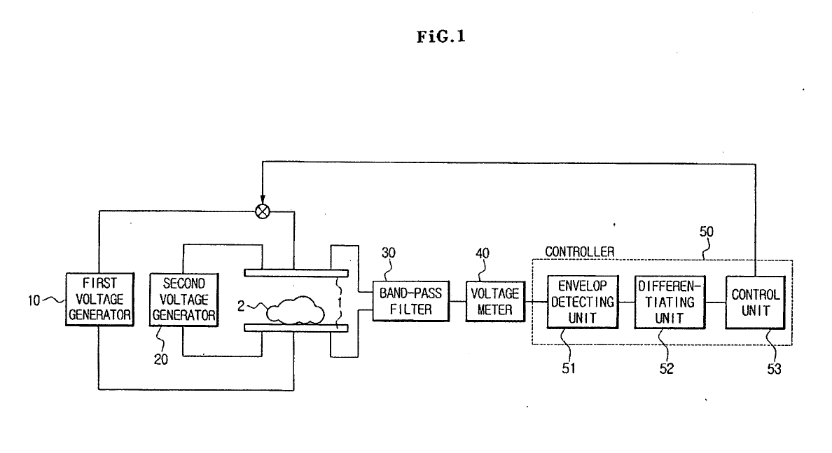

FIG. 1 is a block diagram illustrating the construction of a power control apparatus according to an embodiment of the present invention. Referring to FIG. 1, the power control apparatus includes first and second electrodes 11, 12 oppositely spaced a predetermined distance to each other, a first voltage generator 10 applying first voltage between the first and second electrodes 11 and 12, a second voltage generator 20 applying second voltage for detecting an object put between the first and second electrodes 11 and 12, a voltage meter 40 measuring voltage between the first and second electrodes 11 and 12, and a controller 50 detecting the variance in voltage measured by the voltage meter 40, and if the measured variance is no less than a predetermined threshold value, cutting off the first voltage.

The first voltage generator 10 generates first voltage of high voltage above a certain dimension for keeping foods fresh, and applies it between the first and second electrodes 11 and 12. The first voltage may be DC voltage, AC voltage having certain frequency, or DC-AC combined voltage. When the first voltage is applied, the foods 2 put between the electrodes 11 and 12 are kept fresh by electric charges introduced into the foods 2.

The second voltage generator 20 is a device for applying, between the first and second electrodes 11 and 12, the second voltage for detecting the ingress of a human body or an object upon putting it between the first and second electrodes 11 and 12. In an embodiment, the second voltage generator 20 applies, between the first and second electrodes 11 and 12, the second voltage having different frequency from the first voltage applied by the first voltage generator 10.

The voltage meter 40 is a device for measuring the voltage between the first and second electrodes 11 and 12 for detecting the human body or the object. In an embodiment, in order to measure only the voltage having the same frequency as the second voltage, a band-pass filter 30 is connected between the electrodes 11, 12 and the voltage meter 40 to filter only the frequency of the second voltage and transmit it to the voltage meter 40.

The controller 50 is a device for if the variance in voltage measured by the voltage meter 40 is no less than a predetermined threshold value, cutting off the first voltage between the first and second electrodes 11 and 12 applied from the first voltage generator 10. The controller 50 may include an envelop detecting unit 51, a differentiating unit 52, and a control unit 53.

The envelop detecting unit 51 detects an envelop value that is obtained by respectively connecting each max. values and min. values of the AC voltage detected by the voltage meter 40. The differentiating unit 52 differentiates the detected envelop value and detects the variance in voltage as a differentiation value. The control unit 53 cuts off the first voltage applied by the first voltage generator 10 if the differentiating unit 52 detects the differentiation value above a threshold value. In an embodiment, if the differentiation value is kept approximately 0 for a certain time after cut-off of voltage, the control unit 53 in turn applies the first voltage between the electrodes 11 and 12.

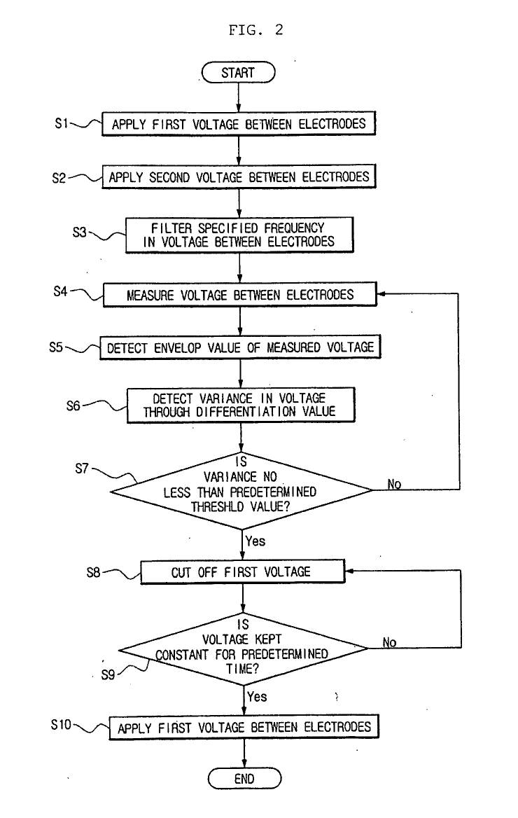

FIG. 2 is a flow chart illustrating a procedure of a power control method according to an embodiment of the present invention. Referring to FIG. 2, the power control method starts with the step of, at the first voltage generator 10, applying first voltage between the first and second electrodes 11 and 12 (S1). The first voltage is for keeping the foods 2, that is to be positioned between the first and second electrodes 11 and 12, fresh so as to restrict the oxidation of the foods 2 and the growth of the microbes in the foods 2. The first voltage may be a high voltage having intensity of 100 V/cm or more.

Next, the second voltage generator 20 applies, between the first and second electrodes 11 and 12, second voltage of detecting voltage for detecting what a human body or an object is put in the space between the first and second electrodes 11 and 12 (S2). The space between the first and second electrodes 11 and 12 has certain impedance, and both the electrodes 11 and 12 are functioned as a capacitor, so that the space has impedance mostly composed of capacitance. If a human body such as a hand or an object is put into the space between the electrodes 11 and 12, dielectric constant between the electrodes is varied, and capacitor values of the electrodes are thus changed, so that impedance and voltage between the electrodes 11 and 12 are also changed.

Thus, when the voltage meter 40 measures the voltage between the first and second electrodes 11 and 12 after the second voltage of the detecting voltage is applied, what the human body or the object is put into the apparatus can be detected. In an embodiment, the band-pass filter 30 is connected between the voltage meter 40 and the electrodes 11 and 12 to thereby transmit, to the voltage meter 40, only the voltage signal having the same frequency as that of the second voltage (S3). In this case, the second voltage generated by the second voltage generator 20 is provided such that it has the different frequency from the first voltage generated by the first voltage generator 10. Thus, it is possible to easily detect a human body or an object using only the second voltage signal ready to detect the human body or the object, excluding a signal by the first voltage generator 10 generating high voltage.

The voltage signal passed through the hand-pass filter 30 is transmitted to the voltage meter 40, which then measures the voltage having the frequency corresponding to that of the second voltage (S4). The voltage measured by the voltage meter 40 is transmitted to the controller 50.

The controller 50 measures the variance in voltage according to the variance in impedance between the electrodes by the human body or the object put between the electrodes 11 and 12, using the voltage between the first and second electrodes 11 and 12 measured by the voltage meter 40. First, the envelop detecting unit 51 included in the controller 50 detects an envelop value that is obtained by respectively connecting each max. values and min. values of the voltage measured by the voltage meter 40 (S5).

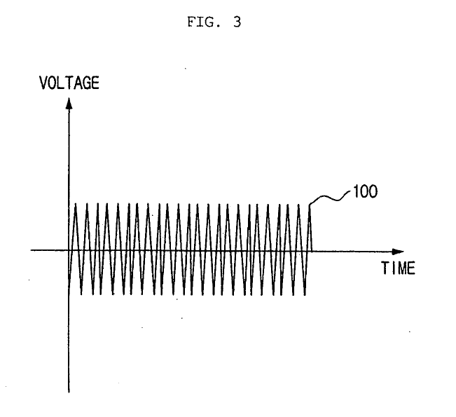

FIG. 3 is a graph illustrating a waveform of voltage measured by the voltage meter 40 when an object is not put between electrodes 11 and 12. Since the second voltage generator 20 applies AC voltage having certain frequency between the electrodes, the voltage measured by the voltage meter 40 is shown as a graph 100 in which a max. value and a min. value are alternating for each certain period.

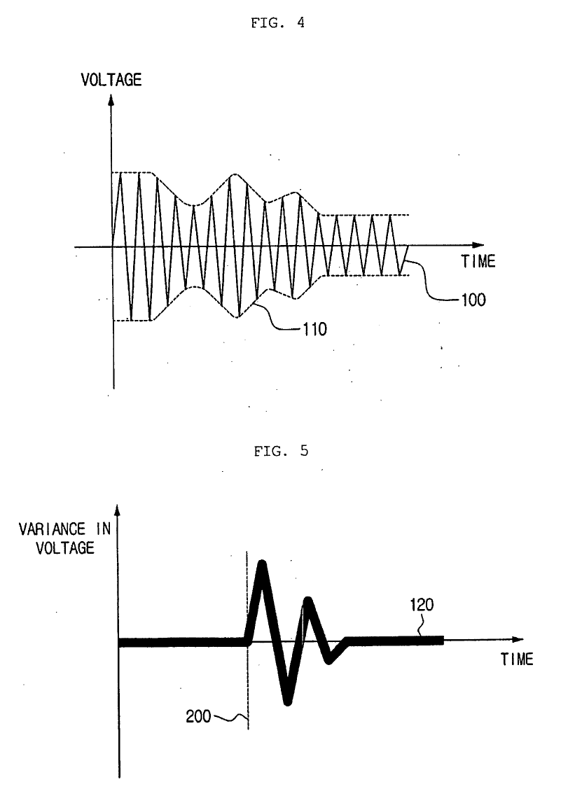

FIG. 4 is a graph illustrating a waveform of voltage measured by the voltage meter 40 when a human body such as a hand is put between electrodes 11 and 12. It can be known that as the human body is put therein, the dielectric constant between the electrodes is varied and the capacitor value is also changed, so that an absolute value of the voltage measured is lowered. A dotted line indicates a graph 110 illustrating the envelop value measured by the envelop detecting unit 51. As described above, the envelop is formed by respectively connecting each max. values and min. values of the voltage, and it can be known that the voltage between the electrodes 11 and 12 is lowered through the graph 110.

After the envelop value is detected by the envelop detecting unit 51, the differentiating unit 52 differentiates the envelop value to obtain a differentiation value (S6). Since the tendency of increase or decrease of the voltage between the electrodes 11 and 12 can be known through the envelop value obtained by the envelop detecting unit 51, it is possible to measure the variance in voltage through differentiation of the envelop value. FIG. 5 is a graph illustrating a value obtained by the differentiating unit 52. As illustrated in FIG. 5, since the voltage is kept constant before a human body or an object is put between the electrodes 11 and 12, a graph 120 that illustrates a differentiation value obtained by differentiating the envelop value is kept 0. On the contrary, a dotted line 200 illustrates a time when the human body is put between the electrodes 11 and 12. As illustrated, after the ingress of the human body, the voltage between the electrodes 11 and 12 is sharply varied so that a larger differentiation value is obtained.

The control unit 53 compares the differentiation value detected by the differentiating unit 52 with a predetermined threshold value (S7). If the differentiation value is no less than the threshold value, which means that the variance in voltage between the electrodes is abnormally large, the control unit 53 determines that the human body or the object is put between the electrodes, and cuts off the first voltage applied by the first voltage generator 10 (S8).

When a user puts his body such as a hand or an object between the first and second electrodes 11 and 12, and then brings back the hand or object from the space between the electrodes 11 and 12, the impedance between the electrodes 11 and 12 will be kept constant. At this time, since high voltage should be applied for keeping the foods fresh, the first voltage of the first voltage generator 10 has to be applied between the electrodes 11 and 12. Thus, in an embodiment, after cutting off the voltage, the control unit 53 checks whether or not the differentiation value detected by the differentiating unit 52 is kept within a predetermined range for a predetermined time (S9). For example, if the differentiation value of the differentiating unit 52 is kept within a certain range from 0 for 10 minutes, which is a sufficient time for coming in and out of the foods, the control unit 53 determines that the human body or the object is removed. Herein, the control unit 53 in turn applies the first voltage between the electrodes 11 and 12 to thereby keep the foods fresh (S10).

According to the apparatus and method for safety power control of an embodiment of the present invention, detecting voltage having frequency different from high voltage is applied between electrodes to which the high voltage is applied, the variance in detecting voltage between the electrodes according to putting of a human body or an object is measured, and if voltage variance above a predetermined value is measured, the high voltage is cut off, so that it is prevented for the human body from being damaged by the high voltage in the apparatus, and that the electrodes for applying high voltage is used as it is, thereby controlling power without installing an additional sensor.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for safety power control comprising:
first and second electrodes oppositely spaced a predetermined distance to each other;
a first voltage generator applying first voltage between the first and second electrodes;
a second voltage generator applying, between the first and second electrodes, second voltage for detecting an object put between the first and second electrodes;
a voltage meter measuring voltage between the first and second electrodes; and
a controller detecting the variance in voltage measured by the voltage meter, and if the measured variance is no less than a predetermined threshold value, cutting off the first voltage.

2. The apparatus for safety power control according to claim 1, wherein the controller applies the first voltage between the first and second electrodes if the voltage measured by the voltage meter after the voltage cut-off is kept constant for a predetermined time.

3. The apparatus for safety power control according to claim 1, wherein the controller comprises:
an envelop detecting unit for detecting an envelop value obtained by respectively connecting each max. values and min. values of the voltage measured by the voltage meter;
a differentiating unit for differentiating the envelop value detected by the envelop detecting unit to thereby detect a differentiation value; and
a control unit for if the differentiation value detected by the differentiating unit is no less than a predetermined threshold value, cutting off the first voltage.

4. The apparatus for safety power control according to claim 3, wherein the control unit applies the first voltage between the first and second electrodes if the differentiation value detected by the differentiating unit after the voltage cut-off is kept within a predetermined range for a predetermined time.

5. The apparatus for safety power control according to claim 1, wherein the first voltage is AC voltage having predetermined frequency, and the second voltage is AC voltage having different frequency from that of the first voltage.

6. The apparatus for safety power control according to claim 5, further comprising a band-pass filter connected between the voltage meter and the first and second electrodes to transmit, to the voltage meter, only the voltage signal having the same frequency as that of the second voltage.

7. A method for safety power control comprising the steps of:
applying first voltage between a first electrode and a second electrode;
applying, between the first and second electrodes, second voltage for detecting an object put between the first and second electrodes;
measuring voltage between the first and second electrodes; and
detecting the variance in voltage measured, and if the measured variance is no less than a predetermined threshold value, cutting off the first voltage.

8. The method for safety power control according to claim 7, further comprising the step of applying the first voltage between the first and second electrodes if the voltage between the first and second electrodes after the voltage cut-off is kept constant for a predetermined time.

9. The method for safety power control according to claim 7, wherein the step of detecting the variance in voltage measured comprises the steps of:
detecting an envelop value obtained by respectively connecting each max. values and min. values of the voltage measured;
differentiating the envelop value detected to thereby defect a differentiation value; and
if the differentiation value detected is no less than a predetermined threshold value, cutting off the first voltage.

10. The method for safety power control according to claim 9, further comprising the step of applying the first voltage between the first and second electrodes if after the voltage cut-off, the differentiation value detected by the step of differentiating the envelop value is kept within a predetermined range for a predetermined time.

11. The method for safety power control according to claim 7, wherein the first voltage is AC voltage having predetermined frequency, and the second voltage is AC voltage having different frequency from that of the first voltage.

12. The method for safety power control according to claim 11, further comprising the step of, before the step of measuring voltage, filtering only the voltage signal having the same frequency as that of the second voltage.
